(19) United States
(12) Patent Application Publication
(10) Pub. No.: US 2008/0302992 A1
(43) Pub. Date: Dec. 11, 2008

(54) STOP VALVE WITH FILTER

(76) Inventor: Ming-Yi LEE, Taipei City (TW)

Correspondence Address: LEONG C LEI, PMB # 1008, 1867 YGNACIO VALLEY ROAD, WALNUT CREEK, CA, 94598, US

(21) Appl. No.: 11/759,234

(22) Filed: Jun. 7, 2007

(51) Int. Cl. F16K 1/22

(52) U.S. Cl. 251/301

(57) ABSTRACT

The interior of the stop valve is partitioned into an upper chamber where the valve mechanism is installed and a lower chamber where a filter is provided. The two chambers are conducted via a through hole of the partition and are connected to two lateral tubular sockets of the stop valve, respectively. The stop valve can further contain a locking mechanism to securely connect a pipe to the stop valve. The locking mechanism mainly contains a tubular element that can be screwed into a tubular socket and a rubber ring washer at the interface between the pipe and a chamber of the stop valve.

### TECHNICAL FIELD OF THE INVENTION

The present invention generally relates to valves, and more particularly to a stop valve having a filter as an integral part.

### DESCRIPTION OF THE PRIOR ART

Stop valves are commonly found in pipe lines. Conventionally, the sole function of a stop valve is for regulating the fluid flowing through the pipe line. To add additional functions to the stop valve, separate parts have to be installed. As shown in FIG. 1, a conventional stop valve A1 is connected to a Y-shaped filtration member A2 with an embedded filter A21 for filtering the fluid flowing through the stop valve A1. The additional provision of the filtration member A2 increases the difficulty and reliability of plumbing, in addition to the added cost of construction.

### SUMMARY OF THE INVENTION

Accordingly, a novel stop valve is provided herein. The interior of the stop valve is partitioned into an upper chamber where the valve mechanism is installed and a lower chamber where a filter is provided. The two chambers are conducted via a through hole of the partition and are connected to two lateral tubular sockets of the stop valve, respectively. As such, the fluid flows through the stop valve via either socket will always pass through the filter and out of the stop valve from the other socket.

The stop valve can further contain a locking mechanism to securely connect a pipe to the stop valve. The locking mechanism mainly contains a tubular element that can be screwed into the tubular socket and a rubber ring washer at the interface between the socket and a chamber of the stop valve. The tubular element, when screwed into the tubular socket, forces the pipe to advance to reliably connect to the stop valve while the ring washer compensates for the gap in the connection developed from temperature change or external influence to the pipe or the stop valve.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiments incorporating the principles of the present invention is shown by way of illustrative example.

### BRIEF DESCRIPTION OF THE DRAWINGS

FIG. 1 is a schematic sectional diagram showing a conventional stop valve.

FIG. 2 is a schematic sectional diagram showing a stop valve according to a first embodiment of the present invention.

FIGS. 3 and 4 are schematic sectional diagrams showing a top valve according to a second embodiment of the present invention.

FIG. 5 is a schematic sectional diagram showing a stop valve according to a third embodiment of the present invention.

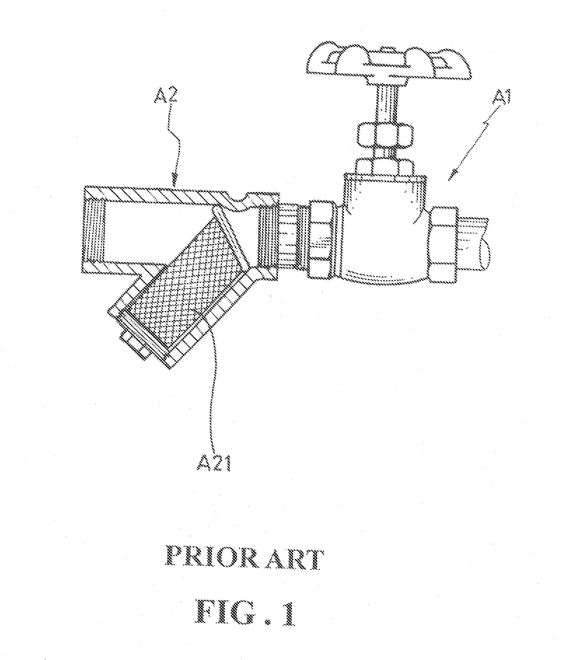

### DETAILED DESCRIPTION OF THE PREFERRED EMBODIMENTS

The following descriptions are exemplary embodiments only, and are not intended to limit the scope applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

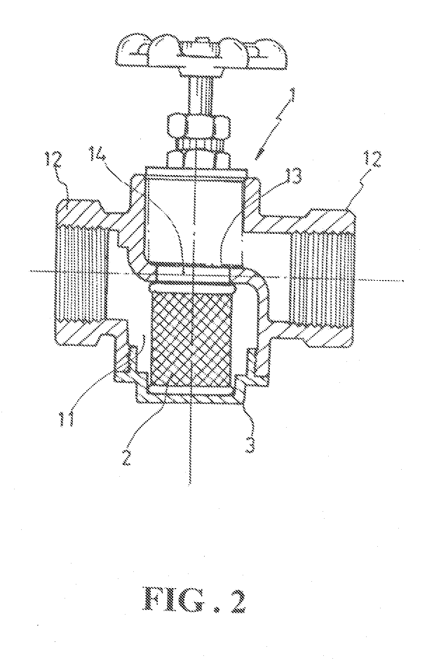

As shown in FIG. 2, an embodiment of the present invention contains a hollow body member 1, a filter 2, and a bottom cap 3. The interior of the body member 1 is separated by a partition 13 into an upper chamber (not numbered) where the valve mechanism (not shown) is accommodated and a lower chamber 11 where the filter 2 is embedded. The partition 13 has a vertical through hole 14 conducting the upper chamber and the lower chamber 11. The body member 1 further contains two lateral tubular sockets 12 with threads around the inner walls conducted to the upper chamber and the lower chamber 11, respectively. The body member 1 further contains a bottom opening (not numbered) screw-joined by the bottom cap 3. By removing the bottom cap 3 to expose the interior of the lower chamber 11, the filter 2 can be easily removed and replaced.

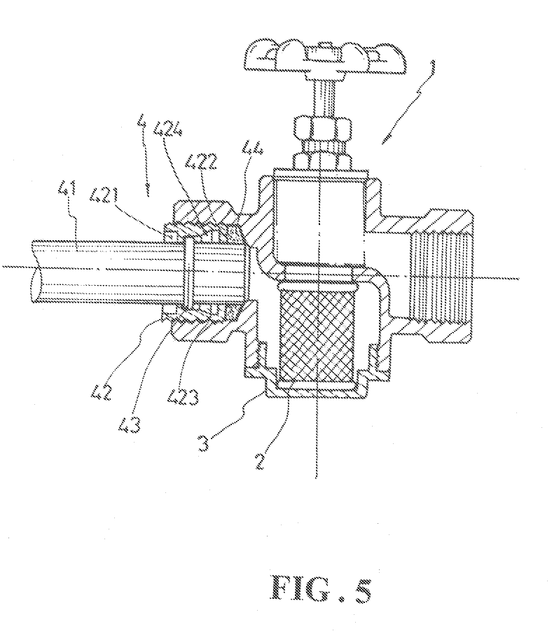

Pipes with appropriate threads around their openings can be screw-joined to the tubular sockets 12 of the stop valve. As shown in FIG. 5, another embodiment of the present invention can further contain a locking mechanism 4 to securely plugging a pipe 41 into a tubular socket 12 to prevent leakage. As illustrated, the locking mechanism contains a rubber ring washer 44 positioned at the bottom of the tubular socket 12 and a tubular element 42 having threads around the outer circumference screw-joined to the tubular socket 12. As the tubular element 42 is screwed into the tubular socket 12, a frond end 422 of the tubular element 42 would tightly press the ring washer 44 against the bottom of the tubular socket 12 (i.e., the entrance to the lower chamber 11 in the present embodiment) to prevent leakage. Inside the tubular element 42 and behind the front end 422 and in front of a back end 421, a horn-shaped space 423 is formed with a slant wall 424 gradually confined towards the back end 421. A C-shaped ring 43 is provided inside the space 423.

A pipe 41 having a circular groove (not shown) at a distance from the end is plugged into the tubular element 42. As the tubular element 42 is screwed into the tubular socket 12, the C-shaped ring would be embedded into the circular groove of the pipe 41 by the slant wall 424, and the tubular element 42 would thereby force the pipe 41 ahead to reliably connect to the entrance of a chamber (i.e., the lower chamber 11 in the present embodiment).

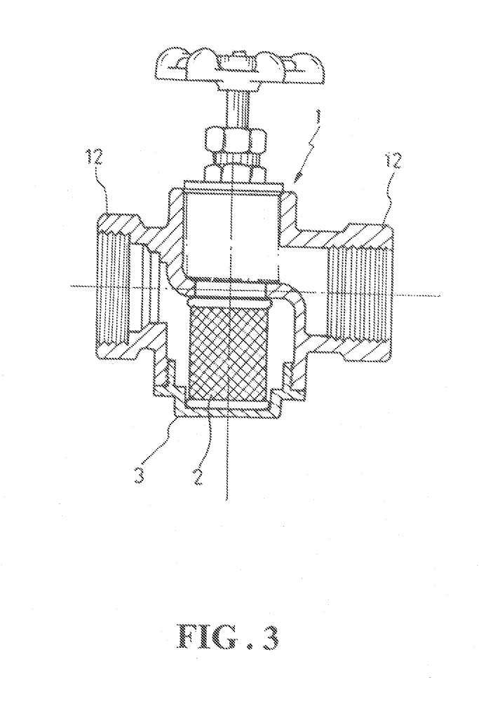

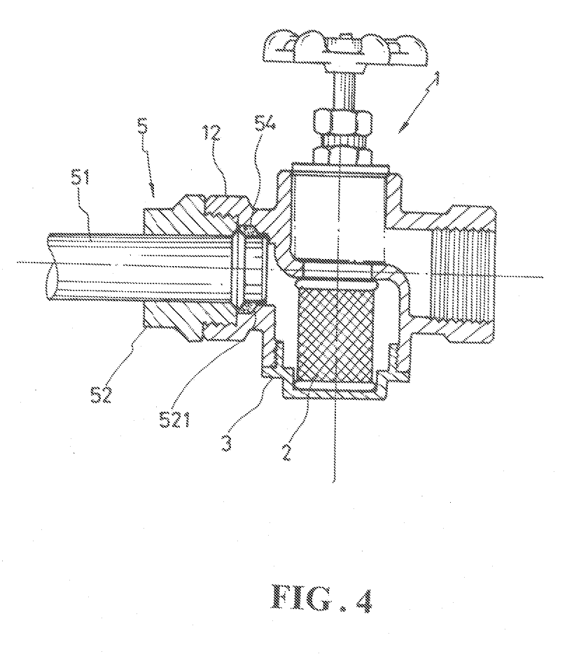

As shown in FIGS. 3 and 4, another embodiment of locking mechanism 5 also contains a rubber ring washer 54 positioned at the bottom of the tubular socket 12. However, the tubular socket 12's interior is gradually confined towards the entrance to a chamber (i.e., the lower chamber 11 in the present embodiment), thereby forming a slant inner wall 521. The locking mechanism 5 also contains a tubular element 52 as part of a pipe 51 behind a flange (not numbered). The tubular element 52 has appropriate threads around its outer circumference so as to be screw-joined with the tubular socket 12. To connect the pipe 51 to the tubular socket 12, the ring washer 54 is first placed inside the tubular socket 12 and, then, the tubular element 52 is screwed into the tubular socket 12. As the tubular element 52 advances, it pushes the flange and therefore advances the pipe 51 forward to tightly connect to the entrance of a chamber (i.e., the lower chamber 11 in the present embodiment). The ring washer 54 there provides secure connection to prevent leakage.

When the pipes are pulled or shook, or when there is a temperature change causing the stop valve and the pipes to expand or shrink differently, some gap would develop in the connection between the pipes and the stop valve, the ring washers in the foregoing embodiments are able to compensate such gap and therefore provide reliable leakage prevention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A stop valve with filter, comprising:
a filter;
a bottom cap; and
a body member having two tubular sockets for the connection of pipes and a bottom through hole removably sealed by said bottom cap;
wherein the interior of said body member is separated by a partition into an upper chamber where the valve mechanism of said stop valve is provided and a lower chamber beneath said upper chamber where said filter is provided; a through hole of said partition conducts said upper and lower chambers; said upper and lower chambers are connected to said tubular sockets, respectively; and the interior of said lower chamber is accessible via said bottom through hole.

2. The stop valve according to claim 1, further comprising:
a ring washer at the bottom of a tubular socket;
a tubular element screw-joined to said tubular socket, a front end of said tubular element facing said ring washer, a horn-shaped space formed inside said tubular element between said front end and a back end with a slant wall gradually confined towards said back end; and
a C-shaped ring provided within said horn-shaped space;
wherein, when a pipe having a circular groove at a distance from the end is plugged into said tubular element and as said tubular element is screwed into said tubular socket, said C-shaped ring is forced to embed into said circular groove, and said slant wall thereby force said pipe ahead by pressing said C-shaped ring to reliably connect to the entrance of a chamber.

3. The stop valve according to claim 1, further comprising:
a ring washer at the bottom of a tubular socket;
a tubular element as part of a pipe positioned behind a flange of said pipe;
wherein the interior of said tubular socket is gradually confined towards the entrance to a chamber, thereby forming a slant inner wall; and when said tubular element is screwed into said tubular socket and as said tubular element advances, said tubular element pushes said flange and therefore advances said pipe forward to press against said ring washer and tightly connected to the entrance of a chamber.
